(19) United States
(12) Patent Application Publication
(10) Pub. No.: US 2015/0207345 A1
(43) Pub. Date: Jul. 23, 2015

(54) RECHARGEABLE BATTERY WITH SERIES-CONNECTED, ASYMMETRIC BANKS

(71) Applicant: Apple Inc., Cupertino, CA (US)

(72) Inventors: Thomas C. Greening, San Jose, CA (US); P. Jeffrey Ungar, Sunnyvale, CA (US)

(73) Assignee: Apple Inc., Cupertino, CA (US)

(21) Appl. No.: 14/161,275

(22) Filed: Jan. 22, 2014

(51) Int. Cl. H02J 7/00

(52) U.S. Cl. CPC H02J 7/0014; H02J 7/0054

(57) ABSTRACT

The disclosed embodiments provide a system that balances voltages between battery banks. This system includes a plurality of asymmetric battery banks having differing capacities electrically connected to each other through a series connection. The system also includes a charging circuit configured to charge the plurality of asymmetric battery banks through the series connection. To balance voltages between the battery banks, the system includes a balancing mechanism comprising switching circuitry and an additional switching bank. This balancing mechanism equalizes voltages among the plurality of asymmetric battery banks by using the switching bank to transfer charge among the plurality of asymmetric battery banks during operation of the system, including during charging, discharging, and/or resting.

### BACKGROUND

1. Field

The disclosed embodiments generally relate to battery packs comprised of multiple battery banks coupled through a series connection. More specifically, the disclosed embodiments relate to a method and an apparatus for balancing voltages among series-connected battery banks, wherein the battery banks can have different capacities. In addition, the disclosed embodiments describe how the different voltages between the series-connected battery banks can provide simultaneous and independent load currents while maintaining battery balance.

2. Related Art

When designing battery-based devices, compromises must often be made to the battery design to accommodate competing system needs. Specifically, there are tradeoffs when selecting the number of battery banks to put in series, wherein a battery bank is defined as a set of one or more battery cells in parallel that is then treated as a single unit. Subsystem loads typically require power supply voltages that must be converted from the battery voltage using DC-DC converters, such as buck or boost converters. For most DC-DC converters, the closer the battery voltage is to the target voltage, the more efficient the conversion. Some subsystems may benefit from more banks in series, such as one that is powered by a boost converter to generate a higher voltage, while other subsystems may benefit from fewer banks in series. Therefore, the number of battery banks in series is typically chosen to optimize the overall efficiency, taking into account the power supply requirements of all of the subsystem power supplies.

In addition to conversion losses, power losses arise from the resistive paths between the battery and the input to the subsystem's DC-DC converters. For systems with large resistive paths, more banks in series can reduce overall power loss by passing the power at a higher voltage and a lower current. Placement of the DC-DC converters relative to the battery and to the subsystems is also optimized when possible to reduce loss. Similarly, charging large capacity batteries with more banks in series is often more efficient, because the current is lower for the same power, thereby reducing resistive loss. In short, the selection of the number of battery banks in series typically benefits some subsystems to the detriment of other subsystems, and a compromise must typically be made to optimize overall efficiency.

Suppose a system has some subsystems that are optimized for a two-in-series bank configuration (2S), and other subsystems optimized for a single bank configuration (1S). The designer would typically need to choose a fixed bank configuration, such as a two-in-series configuration, and use less optimal DC-DC converters for generating the lower voltage power supplies. The designer is not allowed to draw current for these lower voltage subsystems directly from the so-called 1S tap between the two banks in series because it would lead to extreme bank imbalance.

The general rule for a battery pack with banks in series is that charging and discharging of the battery pack must come from the top of the series configuration, and that tapping the voltage between banks is not allowed. For instance, if current is drawn from both the 2S tap and the 1S tap in a 2S configuration where both battery banks are identical, then the lower battery bank will be discharged by the sum of the two tapped currents, while the upper battery bank will be discharged only by the current from the 2S tap. Consequently, the lower bank will be discharged first, and no more current can be drawn from either the 1S or the 2S rail even though the upper bank may have remaining charge. Therefore, when connecting battery banks in series, the battery banks must typically match in capacity and impedance, with charging and discharging from the upper bank only; otherwise, the battery pack can suffer from an imbalance condition.

Even if battery packs are designed with balanced banks, imbalance can arise over the life of a battery pack as bank capacities and impedances degrade with time and cycles. An imbalanced battery pack has reduced capacity because the bank with the highest state-of-charge will cause the charging process to terminate, which means that banks with a lower state-of-charge never get fully charged. Additionally, when the battery pack is discharged, the bank with the least charge can cause the discharging process to stop, even though charge may remain in the other banks.

A number of techniques have been developed to handle the imbalance conditions in battery packs. These balancers can be roughly categorized as either passive or active in nature.

Passive balancers are operated by switching resistances in parallel with selected battery banks during the charging process. These resistances act to divert current around the selected banks, which causes the selected banks to charge more slowly, thereby allowing the voltage or state-of-charge to equalize across the banks. Since passive balancers effectively consume the capacity differences, they are typically used during charging only and cannot alleviate imbalance problems that arise during the discharging process. For nominally balanced banks, however, the passive balancer can be implemented with little circuitry and at low cost.

Active balancers are inductor or capacitor based and can operate during charging or discharging, or during rest. Typically the circuitry required for active balancers is more complex, larger, and more costly than that required for passive balancers, but active balancers can be more effective at keeping banks in balance. Since active balancers still consume power related to the amount of imbalance or are limited in their ability to move significant current, battery packs with active balancers are still typically designed to have banks with the same nominal capacity and impedance. Moreover, intentional imbalance is typically avoided and drawing current from between the banks is typically disallowed.

Hence, what is needed is a method and an apparatus for addressing capacity imbalance problems between battery banks without the drawbacks of existing passive balancers or active balancers.

### SUMMARY

The disclosed embodiments provide a system that balances voltages between battery banks. This system includes a plurality of asymmetric battery banks having differing capacities electrically connected to each other through a series connection. The system also includes a charging circuit configured to charge the plurality of asymmetric battery banks through the series connection. To balance voltages between the battery banks, the system includes a balancing mechanism comprising switching circuitry and an additional switching bank. This balancing mechanism equalizes voltages between the battery banks by using the switching bank to transfer charge among the plurality of asymmetric battery banks during operation of the system, including during charging and/or discharging.

In some embodiments, the plurality of asymmetric battery banks includes a first bank and a second bank. In these embodiments, the switching circuitry is configured to equalize voltages between the first bank and the second bank by iteratively: connecting the first bank in parallel with the switching bank to equalize voltages between the first bank and the switching bank; and then connecting the second bank in parallel with the switching bank to equalize voltages between the second bank and the switching bank.

In a variation on the above embodiments, the plurality of asymmetric battery banks also includes a third bank connected in series with the first and second banks, and the balancing mechanism includes a second switching bank. In these embodiments, the switching circuitry is additionally configured to equalize voltages between the second bank and the third bank by iteratively: connecting the second bank in parallel with the second switching bank to equalize voltages between the second bank and the second switching bank; and then connecting the third bank in parallel with the second switching bank to equalize voltages between the third bank and the second switching bank.

In some embodiments, the system includes a plurality of voltage rails, including: a full voltage rail connected to a positive terminal of a furthest battery bank from ground in the series connection; and at least one intermediate voltage rail connected to a positive terminal of an intermediate battery bank that is not the furthest from ground in the series connection.

In some embodiments, each battery bank in the plurality of asymmetric battery banks is coupled to: (1) a sense resistor configured to measure a current flowing through the battery bank; (2) a temperature gauge configured to measure a temperature of the battery bank; (3) safety field-effect transistors (FETs), including a charging FET configured to stop charging of the battery bank, and a discharging FET configured to stop discharging of the battery bank; and (4) a battery-management unit (BMU) front end configured to monitor current and temperature and control the safety FETs for the battery bank.

In a variation on the above embodiments, the system further comprise a gas gauge microcontroller configured to communicate with each of the BMU front ends through a level-shifted or AC-coupled communication interface.

In some embodiments, the safety FETs for each battery bank are low-side FETs, which are coupled to a low voltage terminal of the battery bank.

In some embodiments, each battery bank includes one or more battery cells connected in parallel.

### BRIEF DESCRIPTION OF THE FIGURES

FIG. 1 illustrates a 2S battery pack in accordance with embodiments of the present invention.

FIG. 2 illustrates an asymmetric, balanced 2S/1S battery pack in accordance with an embodiment of the present invention.

FIG. 3 illustrates an asymmetric, balanced 3S/2S/1S battery pack with low-side safety FETs in accordance with an embodiment of the present invention.

FIG. 4 presents a flowchart illustrating the voltage-balancing process for the battery pack illustrated in FIG. 2 in accordance with an embodiment of the present invention.

FIG. 5 presents a flowchart illustrating the voltage-balancing process for the battery pack illustrated in FIG. 3 in accordance with an embodiment of the present invention.

### DETAILED DESCRIPTION

The following description is presented to enable any person skilled in the art to make and use the disclosed embodiments, and is provided in the context of a particular application and its requirements. Various modifications to the disclosed embodiments will be readily apparent to those skilled in the art, and the general principles defined herein may be applied to other embodiments and applications without departing from the spirit and scope of the disclosed embodiments. Thus, the disclosed embodiments are not limited to the embodiments shown, but are to be accorded the widest scope consistent with the principles and features disclosed herein.

The data structures and code described in this detailed description are typically stored on a non-transitory computer-readable storage medium, which may be any device or medium that can store code and/or data for use by a computer system. The non-transitory computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a non-transitory computer-readable storage medium as described above. When a computer system reads and executes the code and/or data stored on the non-transitory computer-readable storage medium, the computer system performs the methods and processes embodied as data structures and code and stored within the non-transitory computer-readable storage medium. Furthermore, the methods and processes described below can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

### Standard 2S Battery Pack

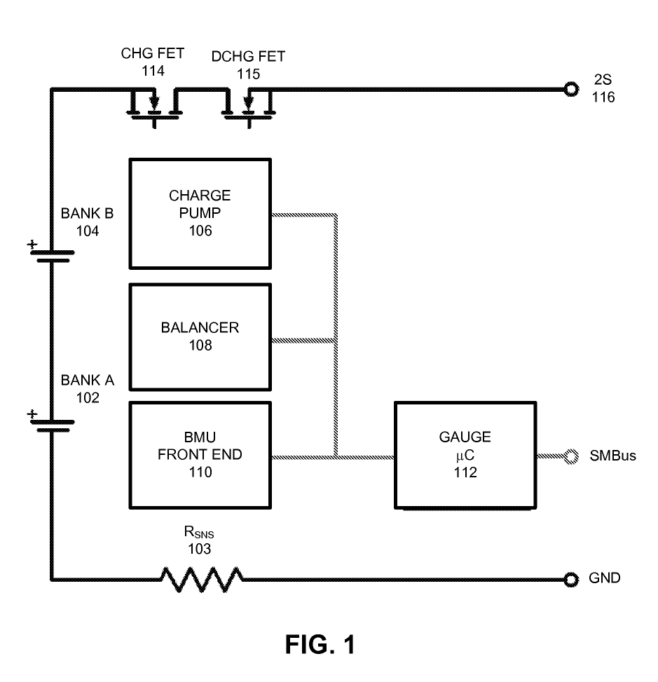

FIG. 1 presents a block diagram of a 2S battery in accordance with the disclosed embodiments. As illustrated in FIG. 1, the 2S battery includes two battery banks, bank A 102 and bank B 104, which are connected in series between ground (GND) and the 2S rail 116. This series connection also incorporates two safety field-effect transistors (FETs), including a charging FET (CHG FET) 114 to stop charging of the battery bank, and a discharging FET (DCHG FET) 115 to stop discharging of the battery bank. Note that because these safety FETs 114-115 are NMOS FETs and are located on the high-voltage side of the series connection, a charge pump 106 is need to generate a high enough voltage to control these safety FETs 114-115.

The system also includes a battery-management unit (BMU) front end 110, which is responsible for measuring the temperature, current, and voltages of both bank A 102 and bank B 104. (Note that current is monitored by measuring the voltage drop across a sense resistor R_{SNS} 103, which is also incorporated into the series connection.) BMU front end 110 communicates with a gas-gauge microcontroller (gauge μC) 112 that performs computational operations based on the temperature current and voltage information obtained by BMU front end 110. Gauge μC 112 uses this information to control charge pump 106 and balancer 108. Note that balancer 108 can be either an “active balancer” or a “passive balancer,” which uses resistors, capacitors or inductors to maintain a voltage or state of charge balance between bank A 102 and bank B 104.

Battery Pack with a Balancing Bank

We now describe a system that uses a special battery bank called a “switching bank” to equalize voltages between series-connected battery banks. To equalize voltages, this switching bank can be switched in parallel between different series-connected banks. This allows current to be drawn from both the top of the battery pack as well as between the battery banks, while keeping the battery pack in balance. Such a battery pack is called an asymmetric, balanced, multi-S battery. The term “multi-S” indicates that the battery can be simultaneously charged or discharged from any series-connected bank. The term “balanced” indicates that all of the banks in the battery pack are nominally kept at the same voltage, such that if they were composed of the same chemistry they would charge to full and empty at the same time, thereby maximizing available capacity. The term “asymmetric” indicates that the battery banks need not be the same capacity, although an optimal asymmetry typically exists for a given system.

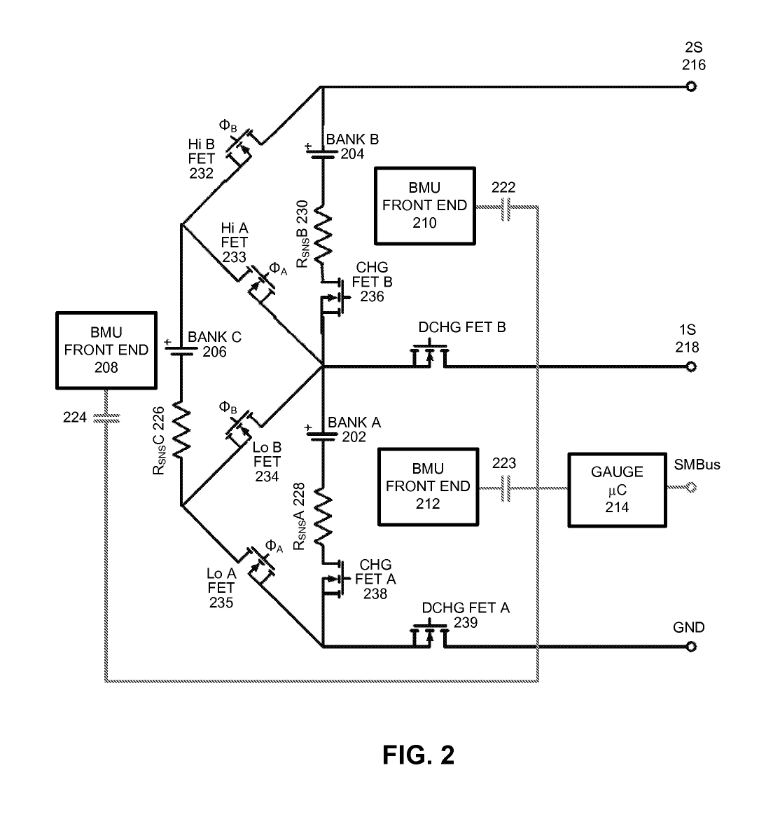

FIG. 2 illustrates the topology of a three-bank battery pack that can be used to simultaneously draw current from both the 2S node 216 and the 1S node 218. Note that bank A 202 and bank B 204 are connected in series, while switching bank C 206 can be connected in parallel with either bank A 202 or bank B 204, depending upon whether the Hi A FET 233 and Lo A FET 235 are enabled, or Hi B FET 232 and Lo B FET 234 are enabled. Note that this battery pack is designed such that Hi/Lo A FETs (233 and 235) and Hi/Lo B FETs (232 and 234) cannot be simultaneously enabled.

The switching bank C 206 operates like the switching capacitor in a switched capacitor circuit, where the current flow through bank C 206, I_{C}, is approximately given by:

$${I}_{C} \approx \frac{( {V}_{B} - {V}_{A} )}{\frac{{V}_{C}}{{Q}_{C} \cdot f} + 2 {R}_{on}} \qquad ( 1 )$$

where Q_{C} is bank C 206's capacity, f is the switching frequency, Rₒₙ is the on-resistance of a single switching FET, and the voltages of banks A 202, B 204, and C 206 are V_{A}, V_{B} and V_{C}, respectively. For a large bank capacity, significant current can be moved while keeping the frequency f relatively low, on the order of once a second. Consequently, the switching losses associated with switching the Hi and Lo FETs 232-235 connected to bank C can be made insignificant.

Equation (1) can be used to estimate the current flowing into and out of bank C 206, but not as accurately as directly measuring the voltage across the sense resistor, R_{SNS}C 226. For accurate gauging, a measurement integrated circuit (IC), shown as the BMU front-end blocks 208, 210 and 212 in FIG. 2, measures the voltage, current, and temperature of a single battery bank. For modularity, these front-end ICs 208, 210 and 212 can be separate chips or, to reduce cost or board space, can be integrated with the microprocessor responsible for gauging the entire pack.

Each BMU front end also controls two safety FETs that allow charging or discharging the bank when enabled. In FIG. 2, these FETs are shown as low-side NFETs. (For example, for battery bank A 202 and associated BMU front end 212, these safety FETs include charge FET A 238 and discharge FET A 239.) NFETs are typically preferred over PFETs, because they have lower on-resistance for the same die size. Most battery gauge implementations prefer high-side NFETs over low-side NFETs, as shown in FIG. 1, so the ground connection and ground-referenced communications are not disrupted when the FETs are off. Since the communications cannot be ground-referenced in the asymmetric, balanced, mixed-S battery anyway, it is preferable to use low-side NFETs that do not require the power-consuming charge pump typically required for driving high-side NFETs. Note that the dedicated charge and discharge FETs are not needed for the switching bank C 206, because the switching bank can be safely disconnected from the system by disabling all four of the switching FETs, shown as Lo and Hi FETs A and B 232-235.

To operate the asymmetric, balanced, multi-S battery, bank C 206 is initially connected in parallel with bank A 202 by enabling both Lo A FET 235 and Hi A FET 233, during phase A. Current will flow between banks A 202 and C 206 bringing them to the same voltage. Then, in phase B, bank C 206 is switched in parallel to bank B 204, by first disabling the Lo A FET 235 and Hi A FET 233, and then enabling Lo B FET 234 and Hi B FET 232. Again, current will flow between banks C 206 and B 204 bringing them to the same voltage. This process is repeated, keeping the voltages of all banks equal, via the switching bank C 206, even with different loads on the 1S and 2S rails. Consequently, the concerns that arise from imbalanced packs are eliminated even as the bank's capacities and impedances change with age and cycling.

In addition to being able to provide simultaneous current at both the 1S and 2S rails, a major advantage of the asymmetric, balanced, multi-S battery is that the capacities of the three banks do not need to be same. For highest performance, the capacities of the banks should be designed in proportion to the expected typical load so that the switching currents are minimized. Since the bank capacities need not be the same, the product can be optimized to maximize the battery volume without restrictions on symmetry. In addition, the process of characterizing and matching cells when building packs in order to minimize imbalance can be eliminated, which reduces manufacturing costs.

Since the banks are allowed to be different sizes, the requirement of an additional bank does not increase the size of the battery pack. The available capacity is simply the sum of the bank's capacities. Hence three smaller banks could take the place of two larger banks in the standard configuration and still provide the same amount of charge.

Since the balancing bank keeps the voltage the same among all banks and not the state-of-charge, the chemistry of the different banks should ideally be the same in order for the states-of-charge of the different banks to be the same when the load currents go to zero.

While the asymmetric, balanced, multi-S battery solves the problems of multi-S discharge and the use of different sized banks while maintaining balance, the design does provide challenges for coulomb counting, pack resistance, and communications.

A valuable component to accurately gauging a battery pack is to integrate the current going into and out of each bank, in a process called the “coulomb count.” In a typical series configured battery, only a single sense resistor is required since the current flowing into each of the banks in series is the same. However, in the asymmetric, balanced, multi-S battery, a sense resistor and separate coulomb count are required for each bank because the currents are different from one another.

In addition to the component cost of the additional sense resistors and coulomb counters, the series resistance of the pack is higher than a standard series configured battery. For instance, even if the asymmetric, balanced, multi-S battery is used in a system that only draws current from the 2S rail, with no current flow into balancing bank C 206, the discharge current still needs to flow through the two sense resistors R_{SNS}A 228 and R_{SNS}B 230 rather than flowing through a single necessary sense resistor R_{SNS} 103 in the standard series configuration battery, shown in FIG. 1.

A standard series configuration battery only requires a single set of charge and discharge FETs for safety, whereas the asymmetric, balanced, multi-S battery requires a set for each charge/discharge rail increasing the series resistance. When discharging from the 2S rail in FIG. 2, even with bank C 206 disabled, the current must traverse three FETs (DCHG FET A 239, CHG FET A 238, and CHG FET B 236) and two sense resistors (R_{SNS}A 228 and R_{SNS}B 230), whereas only two FETs 114-115 and one sense resistor R_{SNS} 103 are in the battery path for the standard series configuration battery illustrated in FIG. 1.

Even with the higher series resistance, the performance of the asymmetric, balanced, multi-S battery typically exceeds the standard series configuration battery due to the efficiency improvements gained by the system being able to use both the 1S and 2S rails.

Communicating with the BMU front ends also presents a challenge because not all of the front ends are ground-referenced. The BMU front end on bank B 204, for instance, is referenced to the 1S rail. Even more challenging, the BMU front end on the switching bank C 206 is sometimes referenced to ground, sometimes referenced to 1S, and sometimes disconnected entirely (except by FET body diodes), depending upon the state of the switching FETs. Consequently, the communications from the ground-referenced system to the BMU front ends need to be either level-shifted or AC-coupled as indicated by the capacitors 222-224 in series with the communication lines in FIG. 2. For AC-coupled communications, a communication protocol without a DC component such as 8b/10b encoding can be used. Alternatively, the communications can be level-shifted by providing the true ground-reference to each of the front ends.

A benefit of a level-shifted or AC-coupled communication interface is that communication is not disrupted when the safety FETs are disabled. In the standard series configuration battery, communication disruption is avoided by putting the safety FETs on the high side. The disadvantage to high-side NFETs is the need for a power consuming charge pump, shown in FIG. 1, to drive the high-side FETs. Alternatively, the standard series configuration battery could use high-side PFETs, which would not require a charge pump, but which would have higher on-resistance.

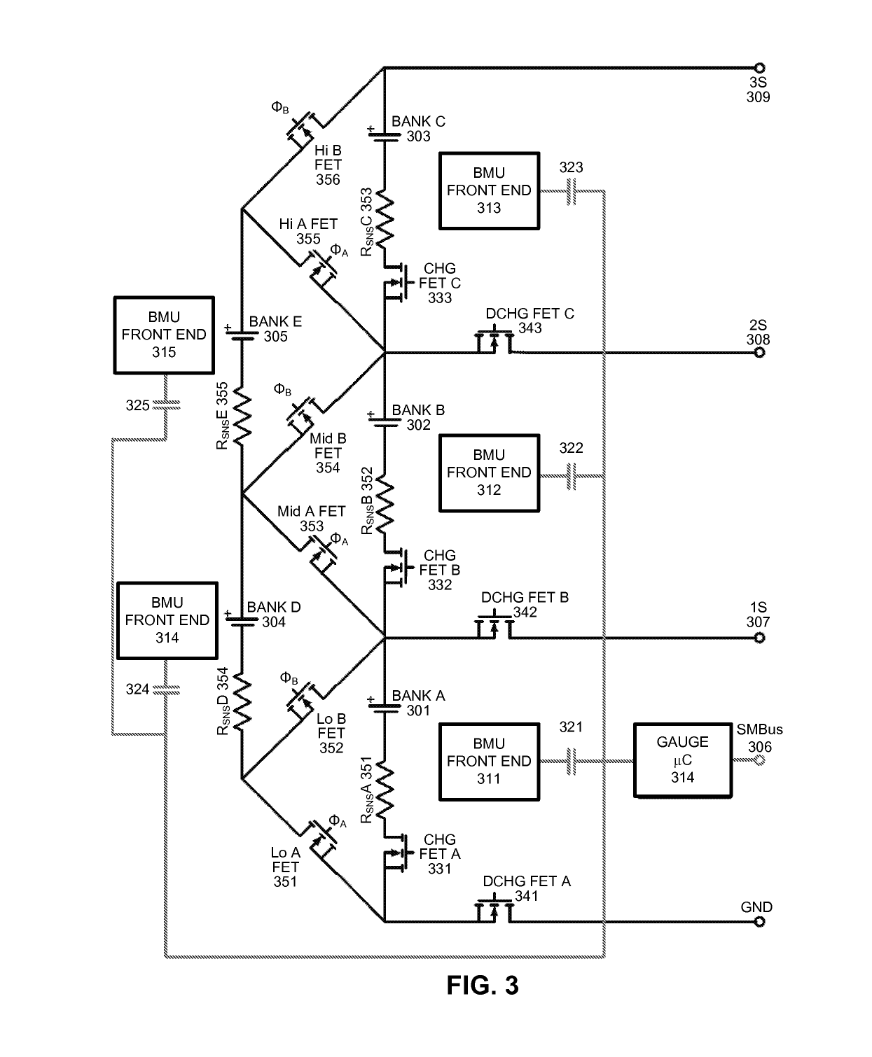

The asymmetric, balanced, multi-S battery is highly modular and easily extendible to any number of batteries in series. For example FIG. 3 shows a three-in-series configuration with two switching banks D 304 and E 305 that can provide power from the 1S 307, 2S 308, and 3S 309 rails. In phase A, the Φ_{A} FETs 355, 353 and 351 are enabled and switching bank D 304 is connected in parallel to bank A 301, while switching bank E 305 is connected in parallel to bank B 302. In phase B, the Φ_{B} FETs 356, 354 and 352 are enabled and switching bank D 304 is connected in parallel to bank B 302, while switching bank E 305 is connected in parallel to bank C 303. Consequently, the voltages of all the banks are kept the same as different load currents are drawn simultaneously from the 1S 307, 2S 308, and 3S 309 rails.

In an alternative embodiment, instead of using two switching banks, the system can use a single switching bank, which is switched among three battery banks A 301, B 302 and C 303. Note that this embodiment requires additional switching circuitry to allow the single switching bank to be electrically connected to the three battery banks A 301, B 302 and C 303.

### Voltage-Balancing Process

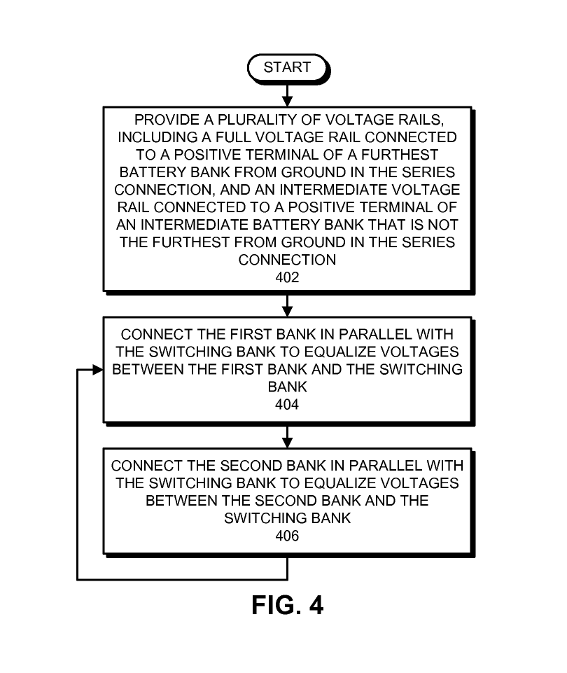

FIG. 4 presents a flowchart illustrating the voltage-balancing process for the battery pack illustrated in FIG. 2 in accordance with an embodiment of the present invention. During this process, the system provides a plurality of voltage rails (step 402). These rails include (1) a full voltage 2S rail 216 connected to a positive terminal of a furthest battery bank from ground in the series connection. (In this case, the furthest battery bank is bank B 204.) It also includes an intermediate voltage 1S rail 218 connected to a positive terminal of an intermediate battery bank that is not the furthest from ground in the series connection. (In this case, the intermediate battery bank is bank A 202.)

While the battery pack is operating, the system equalizes voltages between the first bank and the second bank by iteratively connecting the first bank in parallel with the switching bank to equalize voltages between the first bank and the switching bank (step 404), and then connecting the second bank in parallel with the switching bank to equalize voltages between the second bank and the switching bank (step 406). Note that this iterative switching process can take place at a relatively low frequency, such as once a second. Moreover, the switching process can take place automatically, without having to adjust the switching intervals. Alternatively, the system can temporarily suspend or otherwise modulate the switching operations based on the voltage balance between battery banks.

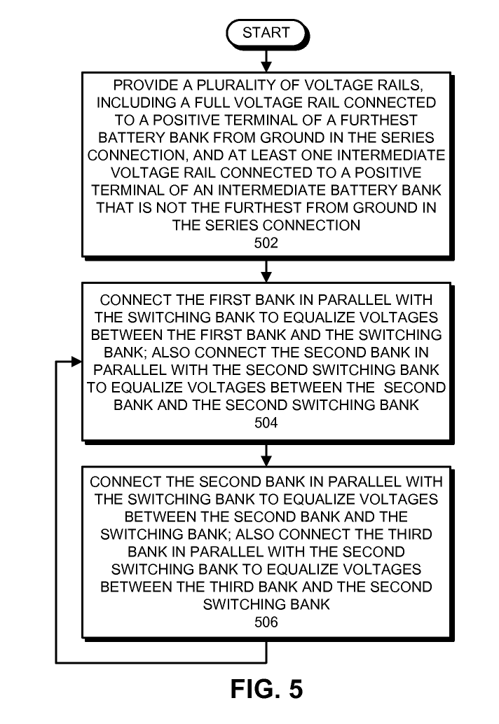

FIG. 5 presents a flowchart illustrating the voltage-balancing process for the battery pack illustrated in FIG. 3 in accordance with an embodiment of the present invention. During this process, the battery system provides a plurality of voltage rails (step 502). These rails include (1) a full voltage 3S rail 309 connected to a positive terminal of a furthest battery bank from ground in the series connection. (In this case, the furthest battery bank is bank C 303.) The rails also include at least one intermediate voltage rail connected to a positive terminal of an intermediate battery bank that is not the furthest from ground in the series connection. (In this case, the intermediate voltage rails include a 2S rail 308 connected to the positive terminal of battery bank B 302, and a 1S rail 307 connected to the positive terminal of battery bank A 301.)

While the battery pack is operating, the system equalizes voltages among the first, second and third banks by iteratively performing the following operations. The system first connects the first bank in parallel with the switching bank to equalize voltages between the first bank and the switching bank. At the same time, the system connects the second bank in parallel with the second switching bank to equalize voltages between the second bank and the second switching bank (step 504). Next, the system connects the second bank in parallel with the switching bank to equalize voltages between the second bank and the switching bank. At the same time, the system connects the third bank in parallel with the second switching bank to equalize voltages between the third bank and the second switching bank (step 506).

### CONCLUSION

The above-described asymmetric, balanced, multi-S battery is capable of improving system runtime by providing simultaneous battery voltage rails without incurring loss of capacity due to imbalance. In addition, the battery banks need not be the same size, thereby eliminating design constraints for the system designer and eliminating the need to bin batteries in the factory in order to build balanced packs.

The foregoing descriptions of embodiments have been presented for purposes of illustration and description only. They are not intended to be exhaustive or to limit the present description to the forms disclosed. Accordingly, many modifications and variations will be apparent to practitioners skilled in the art. Additionally, the above disclosure is not intended to limit the present description. The scope of the present description is defined by the appended claims.

What is claimed is:

1. A rechargeable battery system, comprising:
a plurality of asymmetric battery banks having differing capacities electrically connected to each other through a series connection;
a charging circuit configured to charge the plurality of asymmetric battery banks through the series connection; and
a balancing mechanism comprising switching circuitry and an additional switching bank, wherein the balancing mechanism equalizes voltages among the plurality of asymmetric battery banks by using the switching bank to transfer charge among the plurality of asymmetric battery banks during operation of the system, including during charging and/or discharging.

2. The system of claim 1,
wherein the plurality of asymmetric battery banks includes a first bank and a second bank; and
wherein the switching circuitry is configured to equalize voltages between the first bank and the second bank by iteratively,
connecting the first bank in parallel with the switching bank to equalize voltages between the first bank and the switching bank, and
connecting the second bank in parallel with the switching bank to equalize voltages between the second bank and the switching bank.

3. The system of claim 2,
wherein the plurality of asymmetric battery banks also includes a third bank connected in series with the first and second banks;
wherein the balancing mechanism also includes a second switching bank; and
wherein the switching circuitry is configured to equalize voltages between the second bank and the third bank by iteratively,
connecting the second bank in parallel with the second switching bank to equalize voltages between the second bank and the second switching bank, and
connecting the third bank in parallel with the second switching bank to equalize voltages between the third bank and the second switching bank.

4. The system of claim 1, further comprising a plurality of rails configured to provide different voltages, wherein the plurality of rails includes:
a full voltage rail connected to a positive terminal of a furthest battery bank from ground in the series connection; and
at least one intermediate voltage rail connected to a positive terminal of an intermediate battery bank that is not furthest from ground in the series connection.

5. The system of claim 1, wherein each battery bank in the plurality of asymmetric battery banks is coupled to:
a sense resistor configured to measure a current flowing through the battery bank;
a temperature gauge configured to measure a temperature of the battery bank;
safety field-effect transistors (FETs), including a charging FET configured to stop charging of the battery bank, and a discharging FET configured to stop discharging of the battery bank; and
a battery-management unit (BMU) front end configured to monitor current and temperature, and control the safety FETs for the battery bank.

6. The system of claim 5, further comprising a gas gauge microcontroller configured to communicate with each of the BMU front ends through a level-shifted or AC-coupled communication interface.

7. The system of claim 5, wherein the safety FETs for each battery bank are low-side FETs, which are coupled to a low voltage terminal of the battery bank.

8. The system of claim 1, wherein each battery bank includes one or more battery cells connected in parallel.

9. A method for balancing voltages between battery banks in a rechargeable battery system, comprising a plurality of asymmetric battery banks having differing capacities, including a first bank and a second bank, electrically connected to each other through a series connection, and an additional switching bank, the method comprising:
during operation of the rechargeable battery system, equalizing voltages between the first bank and the second bank by iteratively,
connecting the first bank in parallel with the switching bank to equalize voltages between the first bank and the switching bank, and
connecting the second bank in parallel with the switching bank to equalize voltages between the second bank and the switching bank.

10. The method of claim 9,
wherein the plurality of asymmetric battery banks also includes a third bank connected in series with the first and second banks;
wherein the rechargeable battery system also includes a second switching bank; and
wherein the method further comprises equalizing voltages between the second bank and the third bank by iteratively,
connecting the second bank in parallel with the second switching bank to equalize voltages between the second bank and the second switching bank, and
connecting the third bank in parallel with the second switching bank to equalize voltages between the third bank and the second switching bank.

11. The method of claim 9, further comprising providing a plurality of voltage rails with different voltages, wherein the plurality of rails includes:
a full voltage rail connected to a positive terminal of a furthest battery bank from ground in the series connection; and
at least one intermediate voltage rail connected to a positive terminal of an intermediate battery bank that is not furthest from ground in the series connection.

12. The method of claim 9, wherein each battery bank in the plurality of asymmetric battery banks is coupled to:
a sense resistor configured to measure a current flowing through the battery bank;
a temperature gauge configured to measure a temperature of the battery bank;
safety field-effect transistors (FETs), including a charging FET configured to stop charging of the battery bank, and a discharging FET configured to stop discharging of the battery bank; and
a battery-management unit (BMU) front end configured to monitor current and temperature, and control the safety FETs for the battery bank.

13. The method of claim 12, further comprising a gas gauge microcontroller configured to communicate with each of the BMU front ends through a level-shifted or AC-coupled communication interface.

14. The method of claim 12, wherein the safety FETs for each battery bank are low-side FETs, which are coupled to a low voltage terminal of the battery bank.

15. A rechargeable battery system, comprising:
a plurality of battery banks electrically connected to each other through a series connection;
a charging circuit configured to charge the plurality of battery banks through the series connection;
a plurality of voltage rails configured to provide different voltages, wherein the plurality of voltage rails includes,
a full voltage rail connected to a positive terminal of a furthest battery bank from ground in the series connection, and
at least one intermediate voltage rail connected to a positive terminal of an intermediate battery bank that is not furthest from ground in the series connection; and
a balancing mechanism comprising switching circuitry and an additional switching bank, wherein the balancing mechanism equalizes voltages among the plurality of battery banks by using the switching bank to transfer charge among the plurality of battery banks during operation of the system, including during charging and/or discharging.

16. The system of claim 15, wherein the plurality of battery banks are asymmetric battery banks having differing storage capacities.

17. The system of claim 15,
wherein the plurality of battery banks includes a first bank and a second bank; and
wherein the switching circuitry is configured to equalize voltages between the first bank and the second bank by iteratively,
connecting the first bank in parallel with the switching bank to equalize voltages between the first bank and the switching bank, and
connecting the second bank in parallel with the switching bank to equalize voltages between the second bank and the switching bank.

18. The system of claim 17,
wherein the plurality of battery banks also includes a third bank connected in series with the first and second banks;
wherein the balancing mechanism also includes a second switching bank; and
wherein the switching circuitry is configured to equalize voltages between the second bank and the third bank by iteratively,
connecting the second bank in parallel with the second switching bank to equalize voltages between the second bank and the second switching bank, and
connecting the third bank in parallel with the second switching bank to equalize voltages between the third bank and the second switching bank.

19. The system of claim 15, wherein each battery bank in the plurality of battery banks is coupled to:
a sense resistor configured to measure a current flowing through the battery bank;
a temperature gauge configured to measure a temperature of the battery bank;
safety field-effect transistors (FETs), including a charging FET configured to stop charging of the battery bank, and a discharging FET configured to stop discharging of the battery bank; and
a battery-management unit (BMU) front end configured to monitor current and temperature, and control the safety FETs for the battery bank.

20. The system of claim 19, further comprising a gas gauge microcontroller configured to communicate with each of the BMU front ends through a level-shifted or AC-coupled communication interface.

21. The system of claim 19, wherein the safety FETs for each battery bank are low-side FETs, which are coupled to a low voltage terminal of the battery bank.

22. The system of claim 1, wherein each battery bank includes one or more battery cells connected in parallel.

23. A method for operating a rechargeable battery system, comprising a plurality of battery banks, including a first bank and a second bank, electrically connected to each other through a series connection, and an additional switching bank, the method comprising:
providing a plurality of voltage rails, including,
a full voltage rail connected to a positive terminal of a furthest battery bank from ground in the series connection, and
at least one intermediate voltage rail connected to a positive terminal of an intermediate battery bank that is not furthest from ground in the series connection; and
during operation of the rechargeable battery system, equalizing voltages between the first bank and the second bank by iteratively,
connecting the first bank in parallel with the switching bank to equalize voltages between the first bank and the switching bank, and
connecting the second bank in parallel with the switching bank to equalize voltages between the second bank and the switching bank.

24. The method of claim 23, wherein the plurality of battery banks are asymmetric battery banks having differing storage capacities.

25. The method of claim 23,
wherein the plurality of battery banks also includes a third bank connected in series with the first and second banks;
wherein the rechargeable battery system also includes a second switching bank; and
wherein the method further comprises equalizing voltages between the second bank and the third bank by iteratively,
connecting the second bank in parallel with the second switching bank to equalize voltages between the second bank and the second switching bank, and
connecting the third bank in parallel with the second switching bank to equalize voltages between the third bank and the second switching bank.

26. The method of claim 23, wherein each battery bank in the plurality of battery banks is coupled to:
a sense resistor configured to measure a current flowing through the battery bank;
a temperature gauge configured to measure a temperature of the battery bank;
safety field-effect transistors (FETs), including a charging FET configured to stop charging of the battery bank, and a discharging FET configured to stop discharging of the battery bank; and
a battery-management unit (BMU) front end configured to monitor current and temperature, and control the safety FETs for the battery bank.

27. The method of claim 26, further comprising a gas gauge microcontroller configured to communicate with each of the BMU front ends through a level-shifted or AC-coupled communication interface.

28. The method of claim 26, wherein the safety FETs for each battery bank are low-side FETs, which are coupled to a low voltage terminal of the battery bank.
